(19) United States
(12) Patent Application Publication
(10) Pub. No.: US 2006/0196293 A1
(43) Pub. Date: Sep. 7, 2006

(54) Adjusting device

(75) Inventor: Axel Gerhardt, Wolken (DE)

Correspondence Address: COHEN, PONTANI, LIEBERMAN & PAVANE, 551 FIFTH AVENUE, SUITE 1210, NEW YORK, NY, 10176, US

(73) Assignee: Stabilus GmbH, Koblenz (DE)

(21) Appl. No.: 11/398,124

(22) Filed: Apr. 5, 2006

Related U.S. Application Data
(63) Continuation-in-part of application No. 11/259,005, filed on Oct. 26, 2005.

(30) Foreign Application Priority Data
Nov. 5, 2004 (DE) 10 2004 054 037.3

(51) Int. Cl. F16H 1/24

(52) U.S. Cl. 74/424.92

(57) ABSTRACT

An adjusting device for adjusting two parts relative to one another, has a fixed, sleeve-like housing and an adjusting component which is arranged in the housing and is led with its one end region out of a front-end opening of the sleeve-like housing. By means of a rotary drive, the adjusting component can be adjusted axially relative to the sleeve-like housing by means of a planetary roller mechanism. The sleeve-like housing is arranged in a rotationally locked manner and is provided with a thread on its cylindrical inner wall. The rotary drive is arranged on the likewise rotationally locked adjusting component, this rotary drive having a drive shaft which is coaxial to the sleeve-like housing and by means of which a roller cage can be driven in a rotatable manner about the longitudinal axis of the sleeve-like housing. The roller cage has a plurality of spindles which are parallel to the longitudinal axis of the sleeve-like housing 1 and on which planetary rollers having grooves corresponding to the profile of the thread are in each case mounted in a freely rotatable manner, these planetary rollers engaging by means of their grooves corresponding to the thread in the thread of the sleeve-like housing.

### CROSS-REFERENCE TO RELATED APPLICATIONS

This application is a continuation-in-part of U.S. patent application Ser. No. 11/259,005 which was filed with the U.S. Patent and Trademark Office on Oct. 26, 2005. Priority is claimed on German Application No. 10 2004 054 037.3, filed Nov. 5, 2004.

### BACKGROUND OF THE INVENTION

1. Field of the Invention

The invention relates to an adjusting device for adjusting two parts relative to one another, having a fixed, sleeve-like housing and an adjusting component which is arranged in the housing and is led with its one end region out of a front-end opening of the sleeve-like housing, having a rotary drive, by means of which the adjusting component can be adjusted axially relative to the sleeve-like housing by means of an epicyclic mechanism.

2. Description of the Related Art

Known as an adjusting component in such an adjusting device is a rotationally locked, drive spindle which is displacable by a planetary roller mechanism relative to a hollow shaft provided with thread turns on its inside, the hollow shaft serving as rotor of an electric motor.

The object of the invention is therefore to provide an adjusting device of the type mentioned at the beginning which, in a simple construction, requires a small construction space and permits a manual adjustment of the parts to be adjusted relative to one another.

### SUMMARY OF THE INVENTION

The object of the invention is therefore to provide an adjusting device of the type mentioned at the beginning which, in a simple construction, requires a small construction space and permits a manual adjustment of the parts to be adjusted relative to one another.

This object is achieved according to the invention in that the epicyclic mechanism is a recirculating ball mechanism, and the sleeve-like housing is arranged in a rotationally locked manner and is provided with a thread-turn-like groove on its cylindrical inner wall, and in that the rotary drive is arranged on the likewise rotationally locked adjusting component, this rotary drive having a drive shaft coaxial to the sleeve-like housing and having a thread-turn-like groove, the housing and the drive shaft being coupled to one another by balls arranged in the thread-turn-like grooves.

A further solution consists in the fact that the epicyclic mechanism is a planetary roller mechanism, and the sleeve-like housing is arranged in a rotationally locked manner and is provided with a thread on its cylindrical inner wall, and in that the rotary drive is arranged on the likewise rotationally locked adjusting component, this rotary drive having a drive shaft which is coaxial to the sleeve-like housing and by means of which one or more planetary rollers can be driven in a rotatable manner about the longitudinal axis of the sleeve-like housing or spindles parallel thereto, on which planetary rollers having grooves corresponding to the profile of the thread are in each case mounted in a freely rotatable manner, these planetary rollers engaging by means of their grooves in the thread of the sleeve-like housing.

Since the rotationally movable components move axially with the adjusting component, they may have a small overall length.

The recirculating ball mechanism and the planetary roller mechanism permit a high ratio of force transmission relative to the construction space, the linear movement being effected with a high reduction ratio. The reduction ratio is so high that an additional mechanism stage can usually be dispensed with.

Since, in the case of the planetary roller mechanism, the planetary rollers roll in the thread, there are only slight friction losses, so that the energy applied can serve for the adjusting largely free of losses. The rotary drive can therefore be designed to be relatively small and thus save construction space.

The result of the low friction losses is that the planetary roller mechanism is also not self-locking and thus easy manual adjustability of the parts adjustable relative to one another is also provided for.

The planetary rollers contribute substantially to rigidity of the adjusting device.

It is possible for a roller cage to be capable of being driven in a rotatable manner about the longitudinal axis by the coaxial drive shaft, this roller cage having the plurality of spindles which are parallel to the longitudinal axis of the sleeve-like housing and on which the planetary rollers having grooves corresponding to the profile of the thread are in each case mounted in a freely rotatable manner.

For more uniform force transmission, the spindles are preferably arranged in a uniformly distributed manner on a circle.

If the adjusting component is an adjusting tube, in the tube interior of which the rotary drive is arranged, the maximum adjusting stroke corresponds approximately to the overall length of the adjusting device in the retracted state.

To protect against the ingress of contaminants, the adjusting tube may be closed at its end projecting from the sleeve-like housing, the adjusting tube preferably also being led out of the sleeve-like housing in a sealed-off manner.

The rotary drive may be an electric motor, in particular a direct-current motor.

In order to also be able to transmit higher adjusting forces without any problems, the roller cage may be supported axially on the adjusting tube via an axial bearing, in particular an axial rolling bearing.

The roller cage may have a cage plate which is arranged on the drive shaft in a rotationally fixed manner and to which the axially extending spindles are fastened with their one end region.

For high stability of the roller cage, those ends of the spindles which are opposite the cage plate may be fastened to a second cage plate.

If the interior space of the sleeve-like housing is filled with a gas under prepressure, an extension movement of the adjusting tube can be effected either only by the gas pressure or by the gas pressure assisted by the rotary drive.

The extension movement of the adjusting component can also be assisted by a compression spring acting upon the adjusting component in the extension direction.

Use of nitrogen as pressurized gas additionally protects the housing and the components arranged in the adjusting tube against corrosion.

To convert the rotary movement of the drive shaft from a high speed to a high torque, the roller cage can be driven in a rotatable manner by the rotary drive via a mechanism stage.

A compact type of construction is achieved by an electronic driver for driving the rotary drive being arranged in the adjusting tube.

Furthermore, a temperature sensor for detecting the temperature in the adjusting device may be arranged in the adjusting tube, the output signal of which temperature sensor can be fed to the electronic driver.

To detect the adjusting speed and the adjusting travel, a speed sensor for detecting the revolutions of the drive shaft or of the roller cage may be arranged in particular in the adjusting tube.

In this case, the speed sensor used is preferably a Hall sensor.

Monitoring of the current for the rotary drive together with the speed information from the rotary sensor also enables obstructions to be detected in a sensitive manner.

The electronic driver can distinguish an open position from an obstruction by means of the detected stroke.

For fastening to the parts to be adjusted and if need be for the anti-rotation locking of sleeve-like housing and adjusting component, connection pieces for fastening to the parts to be adjusted relative to one another may be arranged on that end of the sleeve-like housing which is remote from the adjusting component and/or on that end of the adjusting component which is remote from the sleeve-like housing.

As preferred use, the adjusting component is arranged on a tailgate at a distance from a pivot axis of the tailgate, and the sleeve-like housing is arranged on a fixed body component of a motor vehicle.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are hot necessarily drawn to scale and that, unless otherwise indicated, they are merely intended to conceptually illustrate the structures and procedures described herein.

### BRIEF DESCRIPTION OF THE DRAWINGS

FIG. 1 is a cross-sectional view of an epicyclic adjusting device according to the invention, having planetary rollers in a roller cage fixed to the drive shaft;

FIG. 2 is a partial cross-section similar to FIG. 1, having planetary rollers in a freely rotatable roller cage, and a drive roller fixed to the drive shaft; and

FIG. 3 is a partial cross-sectional view of an alternative epicyclic adjusting device, having a recirculating ball mechanism between the drive shaft and the housing.

### DETAILED DESCRIPTION OF THE PRESENTLY PREFERRED EMBODIMENTS

The adjusting device shown has a sleeve-like housing 1 which is closed at its one end and is provided with a thread 2 on its cylindrical inner wall.

At its closed end, the housing 1 has a connection piece 3, with which it is pivotably fastened in a rotationally locked manner about its longitudinal axis 4 to a fixed component, such as, for example, the body of a vehicle.

Arranged on the housing 1 is an adjusting tube 5, which is led with its one closed end region out of the open end of the housing 1 in such a way as to be sealed off by an annular seal 6 and, via a further connection piece 11, is pivotably fastened in a rotationally locked manner about its longitudinal axis 4 to a movable component, such as, for example, a tailgate pivotably linked to the body of a vehicle.

The adjusting tube 5 is arranged in the housing 1 in such a way as to be movable in the direction of the longitudinal axis 4. Arranged in the adjusting tube 5 is a direct-current motor 7, the motor coils of which, as stator 8, are firmly arranged on the inner wall of the adjusting tube 5 and enclose a rotor 9 rotatably mounted coaxially to the longitudinal axis 4 and provided with permanent magnets.

At its end facing the connection piece 11, the rotor shaft 10 of the rotor 9 is rotatably mounted in the adjusting tube 5 via radial rolling bearings 12.

That end of the rotor shaft 10 which faces the connection piece 3 forms a drive shaft 13 for a roller cage 14 of a planetary roller mechanism 15.

The roller cage 14 consists of a first cage plate 16 firmly arranged on the drive shaft 13 and of a second cage plate 17 likewise firmly arranged at a distance therefrom on the drive shaft 13, these cage plates 16, 17 being connected to one another via spindles 18 which are arranged in a uniformly distributed manner on a circle coaxial to the longitudinal axis 4 and are parallel to the longitudinal axis 4.

In this case, the first cage plate is axially supported on the adjusting tube 5 via an axial bearing 19.

Planetary rollers 20 having grooves 21 at their cylindrical lateral surface which correspond to the profile of the thread are in each case mounted in a freely rotatable manner on the spindles 18, and these planetary rollers 20 engage in the thread 2 with their grooves 21 corresponding to the profile of the thread.

Arranged on the support 22 in the adjusting tube 5 is an electronic driver 23, from which a power-supply and control line 24 leads outwards. The direct-current motor 7 for the rotary drive of the planetary roller mechanism 15 can be driven by the electronic driver 23, which may also have a temperature sensor.

Also arranged on the adjusting tube 5 is a Hall sensor 25, by means of which the rotary movement of the drive shaft 13 can be detected and a corresponding signal can be supplied to the electronic driver 23.

The interior space of housing 1 and adjusting tube 5 is filled with nitrogen gas under prepressure.

To extend the adjusting tube 5, nitrogen gas is admitted to it in a piston-like manner and it is moved out of the housing 1. In the process, the rotor 9 and the planetary rollers 20 run along freely without substantial resistance.

To retract the adjusting tube 5, the drive shaft 13 and thus also the roller cage 14 are rotatably driven by the direct-current motor 7. As a result, the planetary rollers 20 roll with their external tooth system 21 in the thread 2 and move the adjusting tube 5 into the housing 1.

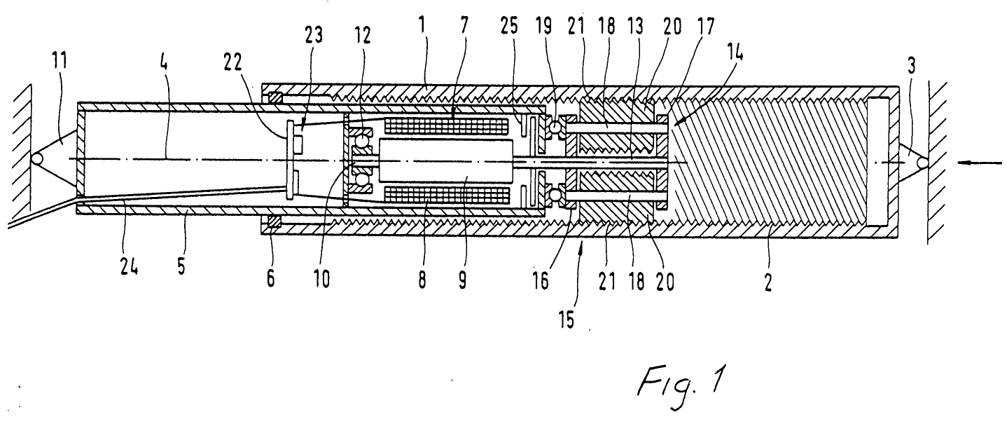

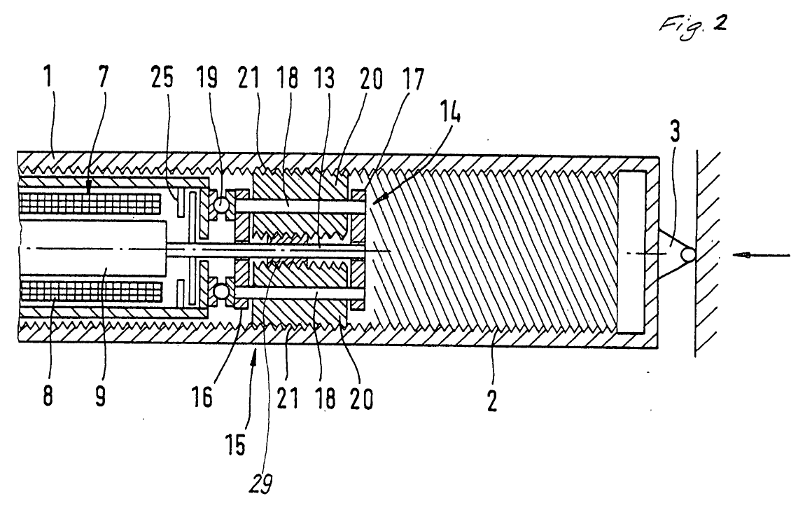

FIG. 2 shows a variation of the planetary roller mechanism of FIG. 1, wherein the roller cage 14 is freely rotatable about the longitudinal axis 4. The planetary rollers 20 are mounted for rotation on spindles 18 in the roller cage, and are driven in rotation by a drive roller 29 fixed to the drive shaft.

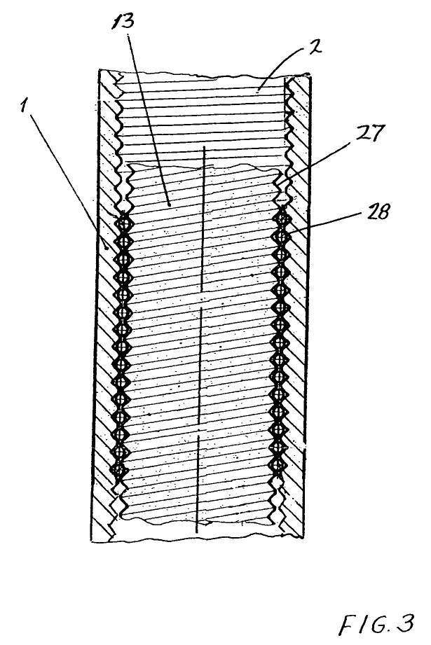

FIG. 3 shows another embodiment of adjusting device according to the invention, wherein the adjusting tube (not shown) is substantially as shown in FIG. 1, and the sleeve-like housing 1 has an inner wall provided with a helical groove 2. Here, however, the epicyclic mechanism is a recirculating ball mechanism rather than a planetary roller mechanism. The upper part of shaft 13 is provided with a helical groove 27, and a plurality of balls 28 are disposed between the groove 27 and the groove 2. When the drive shaft 13 is rotated, the adjusting tube is moved axially relative to the housing 1 by the recirculating ball mechanism.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An adjusting device for adjusting two parts relative to each other, the device comprising:
a sleeve-like housing having a cylindrical inner wall and an end opening, the housing being fixed against rotation, the cylindrical inner wall having a helical groove;
an adjusting component guided through the end opening of the sleeve-like housing and fixed against rotation with respect to the sleeve-like housing;
a rotary drive mounted in the adjusting component and having a drive shaft, the drive shaft being coaxial with the sleeve-like housing and having a helical groove; and
a recirculating ball mechanism comprising a plurality of balls disposed between the helical grooves of the sleeve-like housing and the drive shaft, wherein the rotary drive is operable to move the adjusting component axially relative to the sleeve-like housing via the recirculating ball mechanism when the drive shaft is rotated.

2. An adjusting device for adjusting two parts relative to each other, the device comprising:
a sleeve-like housing having a cylindrical inner wall with a longitudinal axis and an end opening, the cylindrical inner wall having a thread;
an adjusting component guided through the end opening of the sleeve-like housing and fixed against rotation with respect to the sleeve-like housing, the adjusting component having a first end disposed outside the sleeve-like housing, and a second end disposed inside the sleeve-like housing;
a rotary drive mounted in the adjusting component and having a drive shaft coaxial with the sleeve-like housing; and
a planetary roller mechanism comprising a plurality of spindles parallel to the longitudinal axis and a plurality of planetary rollers mounted for rotation on respective said spindles, each said spindle being fixed with respect to the drive shaft, each of the planetary rollers having a groove engaging the thread on the cylindrical inner wall of the sleeve-like housing,
wherein the rotary drive can move the adjusting component axially relative to the sleeve-like housing by rotating the drive shaft when the sleeve-like housing is fixed against rotation.

3. The adjusting device of claim 2, wherein the planetary roller mechanism further comprises a roller cage which is freely rotatable about the longitudinal axis and carries the spindles, and the adjusting device further comprises a drive roller which is fixed on the drive shaft and operable to rotatably drive the planetary rollers freely rotatably carried by the spindles.

4. The adjusting device of claim 2, wherein the planetary roller mechanism further comprises a roller cage which can be rotatably driven about the longitudinal axis by the drive shaft and carries the spindles.

5. The adjusting device of claim 2, wherein the spindles are uniformly distributed on a circle coaxial with the longitudinal axis.

6. The adjusting device of claim 3, wherein the adjusting component is an adjusting tube, and the rotary drive is disposed inside the adjusting tube.

7. The adjusting device of claim 6, wherein the first end of the adjusting tube is closed.

8. The adjusting device of claim 6, wherein the adjusting tube is sealingly guided through the end opening of the sleeve-like housing.

9. The adjusting device of claim 2, wherein the rotary drive is an electric motor.

10. The adjusting device of claim 9, wherein the electric motor is a direct current motor.

11. The adjusting device of claim 6, wherein the roller cage is axially supported by the adjusting tube via an axial bearing.

12. The adjusting device of claim 11, wherein the axial bearing is an axial rolling bearing.

13. The adjusting device of claim 11, wherein the roller cage comprises a first cage plate fixed on the drive shaft, the spindles being fixed to the first cage plate.

14. The adjusting device of claim 3, wherein the roller cage comprises a second cage plate spaced from the first cage plate, and the spindles being fixed to the second cage plate.

15. The adjusting device of claim 2, wherein the sleeve-like housing is filled with a pressured gas.

16. The adjusting device of claim 2, further comprising a compression spring urging the adjusting component out of the sleeve-like housing.

17. The adjusting device of claim 4, wherein the rotary drive is operable to rotatably drive the roller cage via a mechanism stage.

18. The adjusting device of claim 6, further comprising an electronic driver disposed inside the adjusting tube for driving the rotary drive.

19. The adjusting device of claim 18, further comprising a speed sensor disposed inside the adjusting tube for detecting revolution speed of one of the drive shaft and the roller cage and sending a revolution speed output signal to the electronic driver.

20. The adjusting device of claim 2, further comprising a connection piece fixed to the first end of the adjusting component and a connection piece fixed to the sleeve-like housing, wherein the two connection pieces can be connected to the two parts to be adjusted relative to each other.
